(19) United States
(12) Patent Application Publication
(10) Pub. No.: US 2011/0071319 A1
(43) Pub. Date: Mar. 24, 2011

(54) METHOD FOR PREPARING HALOGENATED ORGANOPHOSPHINES

(75) Inventors: Serguei I. Zavorine, St. Catharines (CA); John Henry Hillhouse, Niagara Falls (CA); Jeffrey Charles Henry Dyck, St. Catharines (CA); Angelo melaragni, Welland (CA)

(73) Assignee: Cytec Canada Inc., Niagara Falls, ON (CA)

(21) Appl. No.: 12/992,278

(22) PCT Filed: May 5, 2009
(86) PCT No.: PCT/IB2009/005781

§ 371 Date: Nov. 12, 2010

Related U.S. Application Data
(60) Provisional application No. 61/057,990, filed on Jun. 2, 2008.

(51) Int. Cl. C07F 9/52

(52) U.S. Cl. 568/16

(57) ABSTRACT

The present application relates to a process for preparing a halogenated organophosphine, comprising reacting a primary or secondary organophosphine with a halogenating agent selected from (A) a compound of formula (I): (HaI)₃C—C(O)—X (I) wherein X is selected from alkyl, aryl, aralkyl, alkaryl, cycloalkyl, NR¹R², C(HaI)₃, OR³, -0—C(O)—R^{3′}, or —Y—Z—Y—C(O)—C(HaI)₃; R1 and R2 are each independently selected from hydrogen, alkyl, aryl, aralkyl, alkaryl, or cycloalkyl; R3 is selected from H, alkyl, aryl, aralkyl, alkaryl, cycloalkyl, or triorganosilyl; R^{3′} is selected from C(HaI)₃, alkyl, aryl, aralkyl, alkaryl, cycloalkyl; Y is independently selected from 0 or NH; Z is independently selected from alkylene, arylene, aralkylene, alkarylene, or cycloakylene; and Hal is selected from Cl or Br; or (B) a derivative of a polyol, polyamine or polyaminoalcohol comprising two or more hydroxyl and/or amino groups, in which a hydrogen atom in each of the hydroxyl and/or amino groups is replaced with a group —C(O)—C(HaI)₃, wherein Hal is selected from Cl or Br.

### FIELD OF THE INVENTION

This invention relates to new processes for making a halogenated organophosphine, such as a chlorinated organophosphine, from a primary or secondary organophosphine.

### BACKGROUND OF THE INVENTION

Having one or two reactive P-halogen bonds, halogenated organophosphines such as chlorinated organophosphines (also referred to herein as chlorophosphines) are useful as intermediates for the preparation of new phosphorus containing molecules, such as tertiary phosphines.

Both primary and secondary organophosphines are available via numerous routes, including the reaction of phosphine gas with olefins. Preparation of dichlorophosphines (RPCl₂) and monochlorophosphines (R₂PCl) via the chlorination of primary and secondary phosphines has previously been disclosed, and chlorinating agents have been suggested:

U.S. Pat. No. 2,437,796 and U.S. Pat. No. 2,437,798 (C. Walling) disclose the controlled addition of chlorine in an inert solvent at temperatures below 25° C. to produce corresponding chloro compounds from both primary and secondary phosphines.

RPH₂+2 Cl₂→RPCl₂+2 HCl

R₂PH+Cl₂→R₂PCl +HCl

However, these reactions are often not reproducible and the addition of hazardous chlorine must be carefully controlled in order to avoid the formation of polychlorophosphoranes.

Another process is the phosgenation of primary and secondary phosphines:

RPH₂+2 COCl₂→RPCl₂+2 HCl+2 CO

R₂PH+COCl₂→R₂PCl+HCl+CO

However, these reactions typically require an inert solvent and low temperatures, and they often lead to unsatisfactory results. Further, side products of the reaction are corrosive (hydrogen chloride) and highly toxic (carbon monoxide). In addition, phosgene is a highly toxic gas (boiling point is 8.3° C.), which is poisonous both by contact or inhalation. For these reasons, phosgenation requires special equipment.

Such phosgenation reactions are disclosed in A. Michaelis, F. Dittler, Ber., 1879, 12, 338; E. Steiniger, Chem. Ber., 1963, 96, 3184; U.S. Pat. No. 3,074,994 and W. A. Henderson, Jr., S. A. Buckler, N. E. Day, M. Grayson, J. Org. Chem., 1961, 26, 4770-4771.

A further process [A. N. Pudovik, G. V. Romanov, V. M. Pozhidaev. Bull. Acad. Sci. USSR, 1977, V. 26, No. 9, 2014] teaches the use of trichloroacetonitrile in diethyl ether for the preparation of a number of dialkyl- or diarylchlorophosphines from appropriate secondary phosphines.

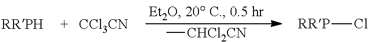

wherein R=R′=Et; R=Et, R′=Ph; R=R′=Bu; R=R′=Ph.

In yet a further process (as disclosed by N. Weferling in U.S. Pat. No. 4,536,350 and Z. Anorg. Allg. Chem., 1987, 548, 55-62) hexachloroethane was used in the preparation of a number of chlorophosphines:

R₃₋ₙPHₙ+n C₂Cl₆→R₃₋ₙPClₙ+n HCL+n C₂Cl₄

n=1, 2; R=c−C₆H₁₁; n=2; R=C₆H₅, t−C₄H₉;

n=1: R=n−C₈H₁₇,

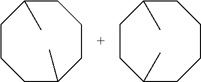

However, those preparations usually require relatively high temperatures (90° C-150° C.) over a period of 2-6 h. Further, hexachloroethane is a potential carcinogen (TWA—1 ppm; IDLH—300 ppm).

In still a further process (U.S. Pat. No. 4,752,648), phosphorus pentachloride was used for the chlorination of both primary and secondary phosphines:

R₃₋ₙPHₙ+PCl₅→R₃₋ₙPClₙ+n HCl+n PCl₃

n=1, 2; R=c−C₆H₁₁; n=2; R=C₆H₅, sec−C₄H₉;

n=1: R=n−C₄H₉,

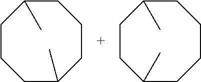

However, phosphorus pentachloride is a highly toxic, corrosive, moisture-sensitive solid, and side products of the reaction, hydrogen chloride and phosphorus trichloride, are corrosive and highly toxic chemicals.

In still a further process, phosphinous chlorides were formed by the reaction of carbon tetrachloride with dialkyl- and diarylphosphines:

R₂PH+CCl₄→R₂PCl+CHCl₃

Such a process is disclosed in GB928,207 (E. Hofmann, Jun. 12, 1963); Y. A. Veits, E. G. Neganova, M. V. Filippov, A. A. Borisenko, V. L. Foss, Zhurnal Obshchei Khimii, 1991, Vol. 61, No. 1, pp. 130-135; P. Majewski, Phosphorus, Sulfur, and Silicon, 1993, Vol. 85, 41-47; P. Majewski, Phosphorus, Sulfur, and Silicon, 1994, Vol. 86, 181-191; and P. Majewski, Phosphorus, Sulfur, and Silicon, 1998, Vol. 134/135, 399-406.

Finally, diorganodihalogenphosphonium halides react with secondary phosphines producing appropriate phosphinous chlorides as exemplified below by the reaction of dicyclohexyldichlorophosphonium chloride with dicyclohexylphosphine (WO/02070530 A1):

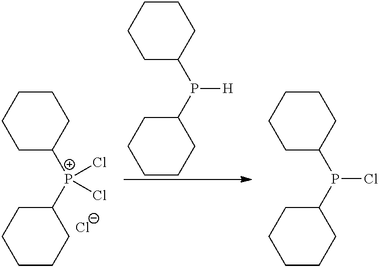

While primary and secondary chlorophosphines are presently available from the known methods above, many of the recited methods have serious drawbacks. For example, chlorination with gaseous chlorine is often not reproducible, and is difficult to control because of the formation of polychlorinated compounds. Further, carbon tetrachloride is an ozone-depleting agent and its application strictly regulated. In addition, phosphorus pentachloride is a moisture-sensitive, corrosive solid that is difficult to handle and requires a solvent. Side-products from using phosphorus pentachloride, being hydrogen chloride and phosphorus trichloride, are also corrosive and very hazardous. Still further, hexachloroethane suffers from environmental issues. Finally, phosgenation, which is often considered the preferred method of chlorination, typically requires low temperatures and is often not reproducible. Phosgene is also extremely toxic and its use, even in a laboratory environment, requires a great deal of precautions.

In view of the above, there is a strong need for new alternative processes for halogenation of primary and secondary phosphines, which will avoid or minimise the use of hazardous reagents, and avoid the use of low temperatures (cryogenics).

### BRIEF SUMMARY OF THE INVENTION

In one aspect, the present invention provides a process for preparing a halogenated organophosphine, comprising reacting a primary or secondary organophosphine with a halogenating agent selected from

(A) a compound of formula (I):

(Hal)₃C—C(O)—X (I)
wherein:
X is selected from alkyl, aryl, aralkyl, alkaryl, cycloalkyl, NR¹R², C(Hal)₃, OR³, —O—C(O)—R^{3′}, or —Y—Z—Y—C (O)—C(W)₃;
R¹ and R² are each independently selected from hydrogen, alkyl, aryl, aralkyl, alkaryl, or cycloalkyl;
R³ is selected from H, alkyl, aryl, aralkyl, alkaryl, cycloalkyl, or triorganosilyl;
R^{3′} is selected from C(Hal)₃, alkyl, aryl, aralkyl, alkaryl, cycloalkyl;
Y is independently selected from O or NH;
Z is independently selected from alkylene, arylene, aralkylene, alkarylene, or cycloakylene;
W is selected from hydrogen or Hal; and
Hal is selected from Cl or Br; or
   (B) a derivative of a polyol, polyamine or polyaminoalcohol comprising two or more hydroxyl and/or amino groups, in which a hydrogen atom in each of the hydroxyl and/or amino groups is replaced with a group —C(O)—C(Hal)₃, wherein Hal is selected from Cl or Br.

### DETAILED DESCRIPTION OF THE INVENTION

As employed herein, “alkyl” refers to straight or branched chain alkyl radicals having in the range of 1 to 12 carbon atoms, optionally substituted by alkoxy (of an (optionally lower) alkyl group), aryl, halogen, trifluoromethyl, cyano, carboxyl, carbamate, sulfonyl, or sulfonamide;

“lower alkyl” refers to straight or branched chain alkyl radicals having in the range of 1 to 4 carbon atoms;

“cycloalkyl” refers to cyclic ring-containing radicals containing in the range of 3 to 14 carbon atoms, optionally substituted by one or more substituents as set forth above; this term also encompasses fused cyclic radicals and bridged cyclic radicals, as well as cyclic radicals containing one or more heteroatoms (e.g., N, O, S, or the like) as part of the ring structure;

“aryl” refers to aromatic radicals having in the range of 6 to 14 carbon atoms, optionally substituted by one or more substituents as set forth above;

“alkaryl” refers to alkyl-substituted aryl radicals, optionally substituted by one or more substituents as set forth above;

“aralkyl” refers to aryl-substituted alkyl radicals, optionally substituted by one or more substituents as set forth above;

“alkylene” refers to divalent alkyl radicals, optionally substituted by one or more substituents as set forth above;

“arylene” refers to divalent aryl radicals, optionally substituted by one or more substituents as set forth above;

“aralkylene” refers to divalent aralkyl radicals, optionally substituted by one or more substituents as set forth above;

“alkarylene” refers to divalent alkaryl radicals, optionally substituted by one or more substituents as set forth above; and

“cycloakylene” refers to divalent cycloalkyl radicals, optionally substituted by one or more substituents as set forth above.

Chlorinating Agent

In one embodiment of the present invention, the halogenating agent selected from a compound of formula (I):

(Hal)₃C—C(O)—X (I)

wherein X is selected from alkyl, aryl, aralkyl, alkaryl, cycloalkyl, NR¹R², C(Hal)₃, OR³, —O—C(O)—R^{3′}, or —Y—Z—Y—C(O)—C(W)₃; R¹ and R² are each independently selected from hydrogen, alkyl, aryl, aralkyl, alkaryl, or cycloalkyl; R³ is selected from H, alkyl, aryl, aralkyl, alkaryl, cycloalkyl, or triorganosilyl (e.g. trimethylsilyl, triethylsilyl, tert-butyldimethylsilyl, iso-propyldimethylsilyl, phenyldimethylsilyl, and di-tert-butylmethylsilyl); R^{3′} is selected from C(Hal)₃, alkyl, aryl, aralkyl, alkaryl, cycloalkyl; Y is independently selected from O or NH; Z is independently selected from alkylene, arylene, aralkylene, alkarylene, or cycloakylene; W is selected from hydrogen or Hal, and Hal is selected from Cl or Br.

In a further embodiment, the halogenating agent is a compound of formula I wherein X is CCl₃, an alkoxy group or an aryl group. In still a further embodiment, the halogenating agent is a trichloroacetate, e.g. methyl, propyl, n-propyl, isopropyl, cyclopropyl, butyl (n-,iso-,sec-, or tert), pentyl (n-, iso-,sec-, tert-, neo), hexyl (or its isomers), heptyl (or its isomers), octyl (or its isomers), nonyl (or its isomers), decyl (or its isomers), undecyl (or its isomers), dodecyl (or its isomers), tridecyl (or its isomers), tetradecyl (or its isomers), phenyl (or a derivative thereof) or naphthyl trichloroacetate. The halogenating agent can also be an alkylene, arylene, aralkylene, alkarylene, or cycloakylene moiety bearing two trichloroacetato or trichloroacetamido groups, or a single trichloroacetato or trichloroacetamido group and a methylacetate group.

In another embodiment of the invention, the halogenating agent is a derivative of a polyol, polyamine or polyaminoalcohol comprising two or more hydroxyl and/or amino groups, in which a hydrogen atom in each of the hydroxyl and/or amino groups is replaced with a group —C(O)—C(Cl)₃ or a group —C(O)—C(Br)₃. The resulting derivative is accordingly a molecule, which can optionally be oligomeric or polymeric in nature, bearing two or more trihalogenated acetato and/or acetamido groups. In one embodiment, the resulting derivative is an oligomeric or polymeric molecule bearing two or more trihalogenated acetato and/or acetamido groups.

Examples of suitable halogenating agents include, without limitation:

(i) hexachloroacetone,

(ii) ethyl trichloroacetate,

(iii) tert-butyl trichloroacetate,

(iv) octyl trichloroacetate,

(v) 2-ethylhexyl trichloroacetate,

(vi) phenyl trichloroacetate,

(vii) naphthyl trichloroacetate,

(viii) ethane-1,2-diyl bis(trichloroacetate), i.e. [(Cl)₃C—C(O)—O—CH₂—CH₂—O—C(O)—C(Cl)₃],

(ix) 2-acetoxyethyl trichloroacetate, i.e. [(Cl)₃C—C(O)—O—CH₂—CH₂—O—C(O)—CH₃],

(x) 2,2-dimethylpropane-1,3-diyl bis(trichloroacetate), i.e. [(Cl)₃C—C(O)—O—CH₂—C(CH₃)₂—CH₂—O—C(O)—C(Cl)₃],

(xi) 2-methylpropane-1,3-diyl bis(trichloroacetate), i.e. [(Cl)₃C—C(O)—O—CH₂—CH(CH₃)—CH₂—O—C(O)—C(Cl)₃],

(xii) 1,4-phenylene bis(trichloroacetate), i.e. [(Hal)₃C—C(O)—O—C₆H₄—O—C(O)—C(Cl)₃],

(xiii) 2-trichloroacetamido)ethyl trichloroacetate, i.e. [(Cl)₃C—C(O)—O—CH₂—CH₂—NH—C(O)—C(Cl)₃],

(xiv) 2-((trichloroacetoxy)methyl)propane-1,3-diyl bis(trichloroacetate), i.e. [(Cl)₃C—C(O)—O—CH₂—CH[CH₂—O—C(O)—C(Cl)₃]₂,

(xv) propane-1,2,3-triyl tris(trichloroacetate), i.e. [(Cl)₃C—C(O)—CH[CH₂—O—C(O)—C(Cl)₃]₂.

or substituted derivatives thereof.

Primary or Secondary Organophosphine

In one embodiment, the primary or secondary organophosphine has the formula:

R⁴R⁵P—H

wherein R⁴ and R⁵ are each independently selected from hydrogen, alkyl, aryl, aralkyl, alkaryl or cycloalkyl, with the proviso that both R⁴ and R⁵ do not simultaneously represent hydrogen.

In a further embodiment, the primary organophosphine is selected from monocycloalkylphosphine, monoarylphosphine or monoalkylphosphine, specific examples of which include monocyclohexylphosphine, mononorbornylphosphine, monophenylphosphine and mono-tert-butylphosphine.

In another embodiment, the secondary organophosphine is selected from dicycloalkylphosphine, diarylphosphine, dialkylphosphine or alkylarylphosphine, specific examples of which include dicyclohexylphosphine, dinorbornylphosphine, diphenylphosphine, isobutylphenylphosphine and di-tert-butylphosphine.

Chlorinated Organophosphine

The nature of the chlorinated organophosphine obtained from the processes of the invention will depend mainly on the nature of the organophosphine reacted with the halogenating agent. For an embodiment of the invention where the organophosphine is a secondary organophosphine and the halogenating agent is a chlorinating agent, the chlorinated organophosphine obtained can, for example, have the formula:

R⁶R⁷P—Cl

wherein R⁶ and R⁷ are each independently selected from alkyl, aryl, aralkyl, alkaryl or cycloalkyl. In another embodiment, the chlorinated organophosphine can be selected from dicycloalkylchlorophosphine, diarylchlorophosphine, dialkylchlorophosphine or alkylarylchlorophosphine, specific examples of which include dicyclohexylchlorophosphine, dinorbornylchlorophosphine, diphenylchlorophosphine, isobutylphenylchlorophosphine and di-tert-butylchlorophosphine.

In another embodiment of the invention where the organophosphine is a primary organophosphine and the halogenating agent is a chlorinating agent, the chlorinated organophosphine obtained can, for example, have the formula:

R⁶P—Cl₂

wherein R⁶ is selected from alkyl, aryl, aralkyl, alkaryl or cycloalkyl. In still another embodiment, the chlorinated organophosphine can be selected from cycloalkyldichlorophosphine, aryldichlorophosphine or alkyldichlorophosphine, specific examples of which include cyclohexyldichlorophosphine, norbornyldichlorophosphine, phenyldichlorophosphine and tert-butyldichlorophosphine.

Reaction Conditions

In one embodiment, the halogenation reactions described herein can be carried out in a variety of solvents, examples of which include acetone, THF, CH₂Cl₂, CHCl₃, chlorobenzene, toluene, xylenes, alkanes such as pentane, hexane, heptane etc., and esters such as ethyl acetate. In another embodiment, the halogenation reaction can be carried out without any solvent. The use of a solvent (or its absence) may help to better control the characteristics of the reaction such as purity, yield, side reactions and digestion time.

The molar ratio of organophosphine to halogenating agent used in the reaction will depend on whether a primary or secondary organophosphine is to be halogenated, and on the amount of halogen atoms that can be obtained from the halogenating agent. For example, a primary organophosphine requires two halogen atoms for complete halogenation, while a secondary organophosphine requires only a single halogen atom. Further, a halogenating agent comprising a single (Hal)₃C— moiety generally provides only a single halogen atom, while agents comprising two or more such groups can provide additional halogen atoms. In one embodiment, an excess of halogenating agent is used in the reaction to insure complete halogenation of the primary or secondary organophosphine. Less halogenating agent can also be used if partial halogenation is sought, or if use of excess halogenating agent leads to the formation of unwanted side-products.

In those embodiments when one or more of the reagents are susceptible to reacting with oxygen or water, the halogenation reactions are carried out under an inert atmosphere, for example under nitrogen or argon atmosphere.

In one embodiment, the halogenation reaction disclosed herein can be carried out at a temperature from −100° C. to about 200° C. For example, the reaction can be carried out at a temperature between 10° C. and 150° C., between 10° C. and 110° C., between 20° C. and 110° C., between 35° C. and 110° C., between 40° C. and 110° C., between 80° C. and 110° C., between 10° C. and 90° C., between 20° C. and 90° C., between 35° C. and 90° C., between 40° C. and 90° C., between 80° C. and 95° C., between 80° C. and 90° C., between 80° C. and 85° C., between 10° C. and 40° C., between 20° C. and 40° C., between 35° C. and 40° C., between 10° C. and 35° C., between 20° C. and 35° C., or at a temperature of about 20° C., about 35° C., about 45° C., about 80° C. or about 110° C.

In one embodiment, the reaction can be carried out under a pressurised atmosphere. The pressurised atmosphere can be used to reduce or negate volatilisation of a solvent when the reaction is carried out in the presence of a solvent and the temperature used would, at standard pressure, promote such volatilisation.

The reaction temperature can be dictated by the reactivity of the halogenating reagent and the organophosphine, by choosing an appropriate solvent, by the rate of addition of one reagent to another, and/or it can be controlled externally, e.g. by cooling or heating the vessel in which the reaction is carried out.

In one embodiment, di-tert-butylphosphine is chlorinated with a trichloroacetate, using no solvent, at a temperature from 80 to 95° C. In another embodiment, dicyclohexylphosphine is chlorinated with a trichloroacetate using chlorobenzene as a solvent and at a temperature from 80 to 90° C.

The yield and purity of the halogenation reactions will depend in part on the techniques utilised to separate the halogenated organophosphines obtained from the above reactions. For example, operating parameters such as reduced pressure and the temperature of removal of volatiles during distillation can have an effect. For embodiments where dicyclohexylchlorophosphine is prepared using ethyl trichloroacetate as the halogenating agent and chlorobenzene as the solvent, the resulting volatile species (chlorobenzene and ethyl dichloroacetate) can be removed at temperatures not exceeding 80-100° C. to minimize the secondary reaction between dicyclohexylchlorophosphine and ethyl dichloroacetate, which leads to the formation of a tar-like material. Wiped-film evaporator (WFE) may also be used to carry out the isolation/purification step.

Advantages

The chlorinating agents disclosed herein display numerous advantages, such as:

The disclosed agents can, for some embodiments, be readily available on a commercial scale.

One mole of hexachloroacetone provides two chlorine atoms producing one mole of dichlorophosphine or two moles of chlorophosphine, and can often be conducted without a solvent. The side-product obtained, tetrachloroacetone, can be conveniently removed in vacuum (b.p. 184° C.).

Ethyl trichloroacetate is a very mild chlorinating agent, and chlorination with this agent can be conducted with or without solvent. Both ethyl trichloroacetate and the obtained side-product, ethyl dichloroacetate, are liquids that can conveniently be removed in vacuum.

The differing boiling points for other dichloroacetates can be used to increase the isolated yield of the obtained halogenated organophosphine since the greater differential between the boiling point of the produced halogenated organophosphine and the side-product (e.g. octyl dichloroacetate) will facilitate separation by distillation.

Tert-butyl trichloroacetate is a solid with a melting point of 25.5° C. Thus, it can be used in a solvent or can be melted and metered to the reaction vessel. When other trichloroacetates are also solids, similar or other techniques available to those skilled in the art could be used.

### EXAMPLES

The following examples are provided to illustrate the invention. It will be understood, however, that the specific details given in each example have been selected for illustration purposes and are not to be construed as limiting the scope of the invention. Generally, the experiments were conducted under similar conditions unless noted.

### Example 1

### Preparation of dicyclohexylchlorophosphine via chlorination of dicyclohexylphosphine with ethyl trichloroacetate

To magnetically stirred dicyclohexylphosphine (1.34 g, 6.8 mmol) under nitrogen atmosphere ethyl trichloroacetate (1.3 g, 7 mmol) was added at ambient temperature. After completion of the exothermic reaction, the reaction mixture was magnetically stirred overnight, after which time the resulting mixture was analysed by ³¹P NMR indicating the presence of dicyclohexylchlorophosphine (83.4%, ³¹P NMR δ=128 ppm).

### Example 2

### Preparation of dicyclohexylchlorophosphine via chlorination of dicyclohexylphosphine in THF with ethyl trichloroacetate

Dicyclohexylphosphine (98.8%, 10.68 g, 53.8 mmol) was added to the reaction flask followed by THF (10.85 g). To the resulting solution, under stirring, ethyl trichloroacetate (97%, 10.52 g, 55 mmol) was added dropwise over a period of 30 min (during the addition, the temperature of the reaction mixture varied from 18° C. to 33° C., by applying an external cooling). The reaction mixture was digested at ambient temperature for two hours (digestion means that the reaction mixture is held at specified conditions for a specified time, optionally under stirring). Following digestion, the reaction mixture was a clear and colourless mobile liquid. The crude reaction mixture was subjected to vacuum distillation (96-100° C/3.6 mbar) resulting in isolation of dicyclohexylchlorophosphine as a clear colourless mobile liquid in 53% yield and high purity (³¹P NMR: 98.78%; GC-FID: 97.26%).

### Example 3

### Chlorination of monocyclohexylphosphine with ethyl trichloroacetate

A nitrogen purged test-tube equipped with magnetic stirring bar was charged with cyclohexylphosphine (0.30 g, 2.6 mmol) followed by ethyl trichloroacetate (1 g, 5.2 mmol). The reaction mixture was held at 110° C. (oil-bath) for 4 hours. The formation of dicyclohexylchlorophosphine was evidenced by GC-MS and ³¹P NMR (77%, ³¹P NMR δ=196.61 ppm).

### Example 4

### Chlorination of dicyclohexylphosphine in chlorobenzene with ethyl trichloroacetate

A solution of dicyclohexylphosphine (98%; 35.30 g, 174 mmol) in chlorobenzene (90.10 g) was heated to 80° C. Ethyl trichloroacetate (30.17 g, 158 mmol) was added dropwise over a period of 46 min while maintaining the temperature of the reaction mixture at 80° C. After additional digestion of the reaction mixture at 80° C. for 1.7 h, it was distilled in vacuo producing dicyclohexylchlorophosphine (29.63 g, 80.6% yield) in 98.9% purity by ³¹P NMR.

### Example 5

### Chlorination of di-tert-butylphosphine with ethyl trichloroacetate without a solvent

Di-tert-butyl phosphine (694.8 g, 4.75 mol) was charged to the reaction flask and heated to 80° C. Ethyl trichloroacetate (909.74 g, 4.75 mol) was added dropwise at a rate so that the temperature of the reaction mixture did not exceed 85° C. (2.5 h overall). Vacuum distillation of the resultant reaction mixture afforded 485 g (57% yield) of di-tert-butylchlorophosphine as clear colourless liquid (98% purity by ³¹P NMR). An additional amount of pure product may potentially be obtained by re-distillation of impure fractions.

### Example 6

### Chlorination of di-tert-butyl phosphine with octyl trichloroacetate

Di-tert-butyl phosphine (13.5 g, 92 mmol) was charged to a three necked round bottomed flask equipped with thermometer, addition funnel and condenser with nitrogen blanket, and heated to 83-84° C. Octyl trichloroacetate (25.4 g, 92 mmol) was added dropwise over a period of 20 min. After completion of the addition, the resultant reaction mixture was digested for an additional 20 min at 70° C., after which time it was analysed by GC indicating the presence of 0.6% unreacted di-tert-butylphosphine.

The addition funnel was removed and the flask was equipped with a short path distillation head. Distillation resulted in two fractions. The fore-cut (1.24 g) was discarded. The second fraction provided 13 g (78.2%) of di-tert-butylchlorophosphine as clear colourless liquid. Boiling point 48-52° C/3.2 mbar (lit. 48° C/3 mmHg). Purity 97% by GC-FID.

### Example 7

### Chlorination of dicyclohexylphosphine with tert-butyl trichloroacetate

A 25 mL nitrogen purged pear shaped flask was charged with dicyclohexylphosphine (1.16 g, 5.9 mmol, 1.2 eq.) followed by tert-butyl trichloroacetate (1.2 g, 4.9 mmol, 1 eq.). The resulting clear colourless solution was magnetically stirred at ambient temperature over a period of three days. After that time, analysis of the reaction mixture by GC-FID and GC-MS showed that the two principal components were the expected dicyclohexylchlorophosphine and tert-butyl dichloroacetate. The reaction mixture was subjected to gradual heating in vacuo (7-8 mmHg) from 70° C. to 170° C. in the oil bath. The reaction mixture was kept at 170° C. for 10 min, after which time it was cooled to ambient temperature. The rather viscous dark red-brownish material was analysed by ³¹P NMR (87% of dicyclohexylchlorophosphine). Analysis of it by gas chromatography showed the presence of residual tert-butyl dichloroacetate.

### Example 8

### Chlorination of dicyclohexylphosphine with hexachloroacetone in ethyl acetate

To the magnetically stirred solution of dicyclohexylphosphine (0.52 g, 2.6 mmol) in ethyl acetate (1 mL), at ambient temperature, a solution of hexachloroacetone (0.35 g, 1.3 mmol) in ethyl acetate (0.5 mL) was added in one portion. The reaction was fast and exothermic; no colour change was observed. After a few minutes heat evolution was finished, and the resulting clear solution was allowed to cool to ambient temperature and was further stirred for an additional 40 min. After that time, the reaction mixture was analysed by GC-MS indicating the formation of dicyclohexylchlorophosphine.

### Example 9

### Preparation of diphenylphosphinous chloride via chlorination of diphenylphosphine with hexachloroacetone

A reaction vessel was equipped with a magnetic stir bar and purged with nitrogen before diphenylphosphine (0.75 g, 4.03 mmol, 1.00 eq.) was charged. Dropwise addition of hexachloroacetone (0.59 g, 2.23 mmol, 0.55 eq.) was started resulting in a strong exotherm after a short induction period. The reaction was cooled in an ice-bath and the addition resumed. The addition was complete after ˜10 min resulting in a clear yellow/orange solution that was allowed to warm to ambient temperature. The reaction mixture became cloudy and was digested for 4 hours. Degassed, anhydrous toluene (5 mL) was added to the yellow suspension and the mixture was allowed to sit for 30 min. A white precipitate settled on the bottom affording a clear yellow supernatant which was analysed by ³¹P NMR and GC/MS proving the formation of diphenylphosphinous chloride.

### Example 10

### Chlorination of monocyclohexylphosphine with hexachloroacetone into dichloro(cyclohexyl)phosphine

A test-tube was equipped with a magnetic stirring bar and purged with nitrogen. Anhydrous toluene (0.74 g) was charged followed by monocyclohexylphosphine (0.26 g, 2.2 mmol, 1.00 eq.). Hexachloroacetone (0.65 g, 2.5 mmole, 1.14 eq.) was added dropwise over a period of ˜3 min. Initially, addition of hexachloroacetone resulted in an exotherm and for this reason, during further addition of hexachloroacetone the test-tube was immersed into an ice-bath. After completion of the addition, the resulting clear colourless liquid was stirred for an additional 5 min under cooling and for an additional 1.5 h at ambient temperature. ³¹P NMR (δ=196.05 ppm, 96.4%) and GC-MS (m/z 184 Da along with M⁺+2 peak in the characteristic ratio of 1.6:1) proved the formation of dichloro(cyclohexyl)phosphine.

### Example 11

### Preparation of dinorbornylphosphinous chloride via chlorination of dinorbornylphosphine with ethyl trichloroacetate without solvent

To a nitrogen purged reaction vessel was added dinorbornylphosphine (0.43 g, 1.9 mmol, 1.00 eq.) followed by the quick addition of ethyl trichloroacetate (0.41 g, 2.1 mmol, 1.1 eq.) via syringe. The resulting reaction mixture turned cloudy within few seconds. After 1 h the absolutely clear reaction mixture was analysed by gas chromatography. The formation of dinorbornylphosphinous chloride was confirmed by the presence in the mass-spectrum of the appropriate M⁺-peak [m/z 256 Da] along with M⁺+2 peak in the characteristic ratio of 3:1.

### Example 12

### Preparation of dinorbornylphosphinous chloride via chlorination of dinorbornylphosphine with ethyl trichloroacetate without solvent

To a nitrogen purged reaction vessel was added dinorbornylphosphine (1.01 g, 4.54 mol, 1.00 eq.) followed by the slow addition of ethyl trichloroacetate (1.10 eq.) via syringe, resulting in an exotherm. After one hour, a sample of the reaction mixture was submitted for ³¹P NMR. The observed chemical shift for the main component (δ=116 ppm, 48.3%) was in agreement with the chemical shifts for phosphinous chlorides.

All publications, patents and patent applications cited in this specification are herein incorporated by reference as if each individual publication, patent or patent application were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustrations and examples for purposes of clarity of understanding, it is readily apparent to those of ordinary skill in the art in light of the teachings of this invention that certain changes and modifications may be made thereto without departing from the spirit or scope of the appended claims.

It must be noted that as used in this specification and the appended claims, the singular forms “a”, “an”, and “the” include plural reference unless the context clearly dictates otherwise. Unless defined otherwise all technical and scientific terms used herein have the same meaning as commonly understood to one of ordinary skill in the art to which this invention belongs.

1. A process for preparing a halogenated organophosphine, comprising reacting a primary or secondary organophosphine with a halogenating agent selected from
(A) a compound of formula (I):
(Hal)₃C—C(O)—X (I)
wherein:
X is selected from alkyl, aryl, aralkyl, alkaryl, cycloalkyl, NR¹R², C(Hal)₃, OR³, —O—C(O)—R³ , or —Y—Z—Y—C(O)—C(W)₃;
R¹ and R² are each independently selected from hydrogen, alkyl, aryl, aralkyl, alkaryl, or cycloalkyl;
R³ is selected from H, alkyl, aryl, aralkyl, alkaryl, cycloalkyl, or triorganosilyl;
R^{3 ′} is selected from C(Hal)₃, alkyl, aryl, aralkyl, alkaryl, cycloalkyl;
Y is independently selected from O or NH;
Z is independently selected from alkylene, arylene, aralkylene, alkarylene, or cycloakylene;
W is selected from hydrogen or Hal; and
Hal is selected from Cl or Br; or
(B) a derivative of a polyol, polyamine or polyaminoalcohol comprising two or more hydroxyl and/or amino groups, in which a hydrogen atom in each of the hydroxyl and/or amino groups is replaced with a group —C(O)—C(Hal)₃, wherein Hal is selected from Cl or Br.

2. The process according to claim 1, wherein the halogenated organophosphine is a chlorinated organophosphine of the formula:
R⁶R⁷P—Cl
wherein R⁶ and R⁷ are each independently selected from alkyl, aryl, aralkyl, alkaryl or cycloalkyl.

3. The process according to claim 1, wherein the halogenated organophosphine is a chlorinated organophosphine of the formula:
R⁶P—Cl₂
wherein R⁶ is selected from alkyl, aryl, aralkyl, alkaryl or cycloalkyl.

4. The process according to claim 1, wherein the primary or secondary organophosphine has the formula:
R⁴R⁵P—H
wherein R⁴ and R⁵ are each independently selected from hydrogen, alkyl, aryl, aralkyl, alkaryl or cycloalkyl, with the proviso that R⁴ and R⁵ are not both hydrogen.

5. The process according to claim 1, wherein X is C(Cl₃).

6. The process according to claim 1, wherein the X is OR³ and R³ is ethyl, tert-butyl, octyl or 2-ethylhexyl.

7. The process according to claim 1, wherein the X is OR³ and R³ is phenyl or naphthyl.

8. The process according to claim 1, wherein X is —Y—Z—Y—C(O)—C(Hal)₃, Y is oxygen, Hal is Cl and Z is selected from phenylene, —CH₂—CH₂—, —CH₂—CH₂—CH₂—, —CH₂—CH(CH₃)—CH₂—, or —CH₂—C(CH₃)₂—CH₂—.

9. The process according to claim 1, wherein the halogenating agent is
(Cl)₃C—C(O)—O—CH₂—CH[CH₂—O—C(O)—C(Cl)₃]₂

10. The process according to claim 1, which is carried out without a solvent.

11. The process according to claim 1, which is carried out in the presence of a solvent selected from acetone, THF, CH₂Cl₂, CHCl₃, chlorobenzene, toluene, xylenes, an alkane or an ester.

12. The process according to claim 11, wherein the alkane is selected from pentane, hexane or heptane.

13. The process according to claim 11, wherein the ester is ethyl acetate.

14. The process according to claim 1, which is carried out at a temperature from −100° C. to 200° C.

15. The process according to claim 1, which is carried out at a temperature from 80to 95° C.

16. The process according to claim 1, wherein the halogenating agent is added to the organophosphine.

17. The process according to claim 1, wherein the organophosphine is added to the halogenating agent.

18. The process according to claim 1, which is carried out in a continuous manner.

19. The process according to claim 1, wherein the halogenated organophosphine is isolated, optionally at elevated temperature, by distillation at atmospheric pressure or distillation under reduced pressure.

20. The process according to claim 1, wherein the halogenated organophosphine is isolated using a wiped-film evaporator (WFE).

21. (canceled)
